(19) United States
(12) Patent Application Publication
(10) Pub. No.: US 2020/0145554 A1
(43) Pub. Date: May 7, 2020

(54) INFORMATION PROCESSING APPARATUS, METHOD FOR PROCESSING INFORMATION AND RECORDING MEDIUM

(71) Applicant: Yutaka MATSUMURA, Kanagawa (JP)

(72) Inventor: Yutaka MATSUMURA, Kanagawa (JP)

(73) Assignee: Ricoh Company, Ltd., Tokyo (JP)

(21) Appl. No.: 16/670,040

(22) Filed: Oct. 31, 2019

(30) Foreign Application Priority Data
Nov. 6, 2018 (JP) 2018-209104

(51) Int. Cl. H04N 1/32

(52) U.S. Cl. CPC H04N 1/32667; H04N 1/32651; H04N 1/32625

(57) ABSTRACT

An information processing apparatus includes a display, at least one memory, and at least one processor electrically coupled to the memory, the processor being configured to: detect the presence or absence of a malfunction of the information processing apparatus; perform a reboot operation upon detecting the malfunction; determine whether or not all modules have finished start-up; suspend the reboot operation to display predetermined information on the display, upon detecting the malfunction at start-up of the information processing apparatus and determining that all modules have not finished start-up; and hide the predetermined information to resume the reboot operation, upon determining that all modules have finished the start-up or detecting a predetermined period elapsing after the malfunction is detected.

### CROSS-REFERENCE TO RELATED APPLICATION

The present application claims priority under 35 U.S.C. § 119 to Japanese Patent Application No. 2018-209104, filed Nov. 6, 2018, the contents of which are incorporated herein by reference in their entirety.

### BACKGROUND OF THE INVENTION

### 1. Field of the Invention

The present disclosure relates to an information processing apparatus, a method for processing information, and a recording medium.

### 2. Description of the Related Art

Information processing apparatuses such as image forming apparatuses are known to automatically perform a reboot (reset, restart) operation without user operations, when a malfunction occurs.

Further, in order to avoid waste of consumables such as toner used in an automatic adjusting process, or loss of time by a reboot, a device is disclosed. When the device receives a reboot instruction in the automatic adjusting process, the device performs a reboot operation after the automatic adjusting process is finished (e.g., Japanese Unexamined Patent Application Publication No. 2007-257580 which may be hereafter referred to as Patent Document 1).

### SUMMARY OF THE INVENTION

In one aspect according to the present disclosure, an information processing apparatus includes a display, at least one memory, and at least one processor electrically coupled to the memory. The processor is configured to: detect the presence or absence of a malfunction of the information processing apparatus; perform a reboot operation upon detecting the malfunction; determine whether or not all modules have finished start-up; suspend the reboot operation to display predetermined information on the display, upon detecting the malfunction at start-up of the information processing apparatus and determining that all modules have not finished start-up; and hide the predetermined information to resume the reboot operation, upon determining that all modules have finished the start-up or detecting a predetermined period elapsing after the malfunction is detected.

### BRIEF DESCRIPTION OF THE DRAWINGS

FIG. 1 is a block diagram illustrating an example of a hardware configuration of an image forming apparatus according to one or more embodiments;

FIG. 2 is a block diagram illustrating an example of a functional configuration of an image forming apparatus according to a first embodiment;

FIG. 3 is a flowchart illustrating an example of the operation of the image forming apparatus according to the first embodiment;

FIG. 4 is a sequence diagram illustrating an example of the operation of the image forming apparatus according to the first embodiment;

FIG. 5 is a diagram illustrating an example of an error screen on a display according to the first embodiment;

FIG. 6 is a block diagram illustrating an example of a functional configuration of the image forming apparatus according to the first embodiment;

FIG. 7 is a flowchart illustrating an example of the operation of an image forming apparatus according to a second embodiment;

FIG. 8 is a sequence diagram illustrating an example of the operation of the image forming apparatus according to the second embodiment; and

FIG. 9 is a diagram illustrating an example of a malfunction screen on a display according to the second embodiment.

### DETAILED DESCRIPTION OF THE EMBODIMENTS

With respect to the information processing apparatus known to the inventor, at start-up of the information processing apparatus (immediately after starting), each module used in the information processing apparatus takes a different amount of time to start up. For this reason, all modules intended for a reboot do not finish starting simultaneously, and as a result, the modules may finish the start-up sequentially. When all the modules are not completely activated, a reboot operation may not be performed properly.

The present disclosure has an object of properly performing a reboot operation automatically when a malfunction occurs, even immediately after the image forming apparatus starts up.

One or more embodiments will be described with reference to the drawings. In each figure, same reference numerals are used to denote the same elements; accordingly, for those elements, explanation may be omitted.

One or more embodiments will be described as using an image forming apparatus as an example for an information processing apparatus.

### Hardware Configuration of Image Forming Apparatus

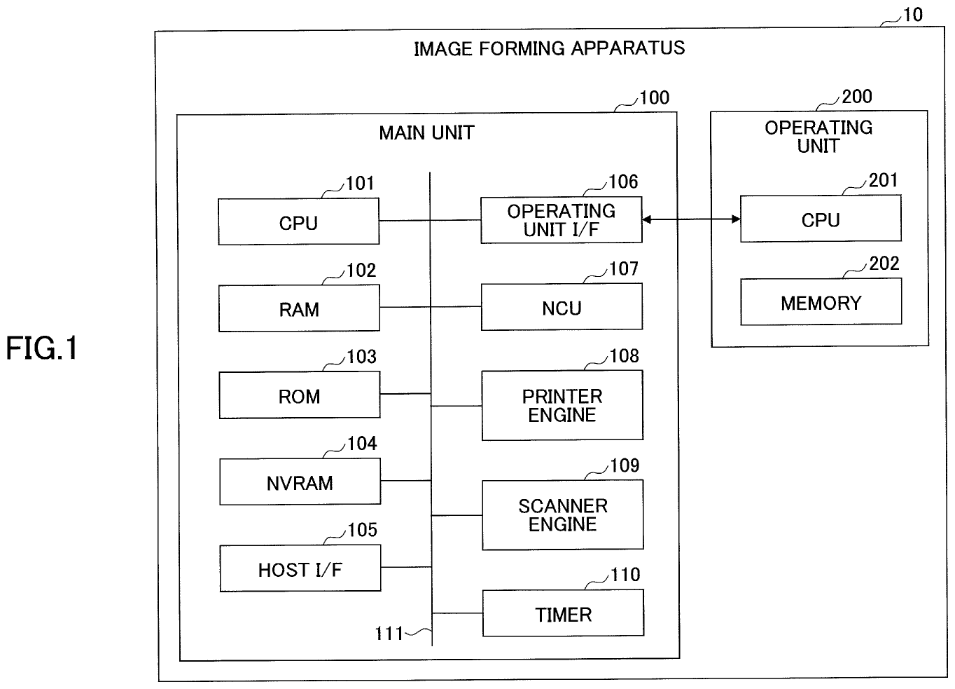

An image forming apparatus 10 according to the embodiments is implemented by a hardware configuration illustrated in FIG. 1. FIG. 1 is a block diagram illustrating an example of the hardware configuration of the image forming apparatus 10.

As illustrated in FIG. 1, the image forming apparatus 10 includes a main unit 100 and an operating unit 200.

The main unit 100 includes a CPU (Central Processing Unit) 101, a RAM (Random Access Memory) 102, a ROM (Read Only Memory) 103, an NVRAM (Non-Volatile Random Access Memory) 104, and a host I/F (Interface) 105.

Further, the main unit 100 includes an operating unit I/F (Interface) 106, an NCU (Network Control Unit) 107, a printer engine 108, a scanner engine 109, and a timer 110. These components are electrically interconnected via a system bus 111.

The RAM 102 temporarily stores one or more programs and data. The ROM 103 stores various programs, data, various types of setting information, and the like. The CPU 101 reads one or more programs, data, setting information, and the like in the ROM 103 or the like, into the RAM 102. The CPU 101 performs processing to allow for control and functions of the entire image forming apparatus 10.

The NVRAM 104 is a memory that is capable of storing data even when the image forming apparatus 10 is turned off.

The host I/F 105 is an interface for receiving print data from an external host device that is not illustrated. Interface types include local connections such as IEEE 1284 standard and USB (Universal Serial Bus), and network connections such as Ethernet (registered trademark) via wired or wireless.

The NCU 107 is coupled to a general public line. When receiving a facsimile or the like, the NCU 107 performs decoding of data or the like.

The printer engine 108 includes an image forming unit that includes one or more photoconductor bodies, a fixing device, and the like. The printer engine 108 forms an image on a print medium such as a paper or outputs a print medium on which an image is formed, etc. in accordance with an instruction from the CPU 101. The scanner engine 109 includes an image scanner, and scans image data from a document. The timer 110 measures elapsed time.

The operating unit 200 includes a CPU 201 and a memory 202. The operating unit 200 is a display device, which receives various inputs according to user operations and displays various types of information. Note that the various types of information include information according to a given operation, information indicating an operational state of the image forming apparatus 10, and information indicating a setting state or the like.

The CPU 201 can retrieve one or more programs, data, setting information, or the like from the memory 202. The CPU 201 performs processing to allow for control and functions of the entire operating unit 200.

The operating unit 200 includes a liquid crystal display (LCD) having a touch panel function, an organic EL (Electro Luminescence) display having a touch panel function, or the like. Additionally or alternatively, the operating unit 200 can include an operating unit such as a hardware key, or a display such as a lamp. Note that a touch on the touch panel described above is an example of “operation.”

### First Embodiment

### Functional Configuration of the Image Forming Apparatus According to the First Embodiment

Hereafter, a functional configuration of the image forming apparatus 10 will be described according to a first embodiment.

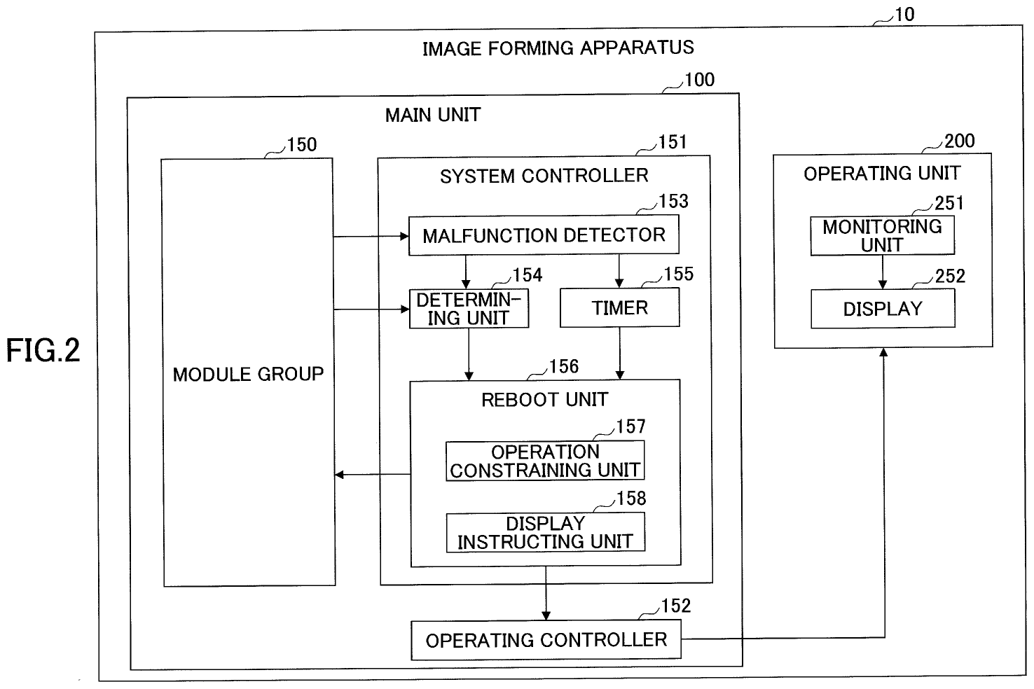

The image forming apparatus 10 according to the first embodiment is implemented by functional blocks or the like illustrated in FIG. 2. FIG. 2 is a block diagram illustrating an example of a functional configuration of the image forming apparatus 10 according to the present embodiment.

Note that in FIG. 2, functional blocks of the image forming apparatus 10 are conceptual, and may not be physically configured as illustrated in FIG. 2. All or some functional blocks may be functionally or physically dispersed in any unit, or be functionally or physically combined in any unit. In FIG. 2, a portion relating to a reboot operation is illustrated.

As illustrated in FIG. 2, the main unit 100 of the image forming apparatus 10 includes a module group 150, a system controller 151, and an operating controller 152.

The module group 150 is a group of control modules included in the main unit 100, except for the system controller 151 and the operating controller 152.

The system controller 151 is a control module that controls the entire system, which includes inter-module control during a reboot of all modules such as the module group 150, an instruction for displaying an error screen, and the like. The system controller 151 includes a malfunction detector 153, a determining unit 154, a timer 155, and a reboot unit 156. The reboot unit 156 includes an operation constraining unit 157 and a display instructing unit 158.

The malfunction detector 153 detects a malfunction of the image forming apparatus 10, and outputs a signal indicating a detected result to the determining unit 154 and the timer 155. The malfunction detector 153 can receive an error signal or the like from each module to detect a malfunction of the image forming apparatus 10.

When a malfunction is detected by the malfunction detector 153, the determining unit 154 determines whether or not all modules have finished start-up, and outputs a signal indicating a determined result to the reboot unit 156. The determining unit 154 may detect one or more activated modules, and output a signal for specifying the one or more activated modules to the reboot unit 156. These functions of the determining unit 154 can be implemented by referring to a status signal indicating an operational status of each module.

The timer 155 measures time elapsing after a malfunction is detected, on a basis of an input signal from the malfunction detector 153, and outputs a signal indicating elapsed time to the reboot unit 156.

When the determining unit 154 determines that all modules have finished start-up, the operation constraining unit 157 executes a process of operation constraints on each module. The reboot unit 156 then performs a reboot operation (reset or restart) of the image forming apparatus 10. The operation constraints include a constraint on new operation of a module, a constraint on interprocess communication, a constraint on access to a memory such as the ROM 103, and the like.

In the present embodiment, when a malfunction is detected at start-up (immediately after starting) of the image forming apparatus 10, in a case where the determining unit 154 determines that all modules have not finished start-up, the reboot unit 156 suspends a process of operation constraints on each module, as well as a reboot operation. The reboot unit 156 further outputs an instruction for displaying an error screen (hereafter may be referred to as a display instruction) to the operating controller 152 via the display instructing unit 158, where on the error screen, information indicating the malfunction is detected is displayed. In the present embodiment, the error screen is an example of “predetermined information”.

Note that the above “start-up” means start-up of the image forming apparatus 10 through a user turning on a power switch or the like, as well as a restart of the image forming apparatus 10 upon rebooting.

After the suspension, when the determining unit 154 determines that all modules have finished the start-up, or when a predetermined period of time elapsing after a malfunction is detected is measured by the timer 155 (when a predetermined period elapses after the detection of malfunction), the reboot unit 156 outputs an instruction for hiding an error screen displayed on the display 252 (hereafter may be referred to as a hiding instruction), to the operating controller 152 via the display instructing unit 158. The reboot unit 156 further resumes a suspended reboot operation.

In the present embodiment, when a predetermined time elapses after the detection of malfunction, the reboot unit 156 may execute a process of operation constraints on only one or more activated modules that are detected by the determining unit 154, and then performs the reboot operation.

The operating controller 152 is a control module that controls an interface with the operating unit 200. The display instruction of an error screen from the reboot unit 156 is outputted to the operating unit 200 via the operating controller 152.

The operating unit 200 includes a monitoring unit 251 and a display 252.

The monitoring unit 251 is a control module that controls an interface with the main unit 100. The monitoring unit 251 receives, from the operating controller 152, a display instruction of an error screen from the display instructing unit 158.

The display 252 is a control module for displaying an error screen or the like. The display 252 displays an error screen in accordance with the display instruction received from the monitoring unit 251.

Note that in the present embodiment, an example in which a display 252 is included in the operating unit 200 is illustrated. However, the display 252 may be separate from the operating unit 200.

### Operation of Image Forming Apparatus According to the First Embodiment

Hereafter, the operation of the image forming apparatus 10 will be described according to the present embodiment.

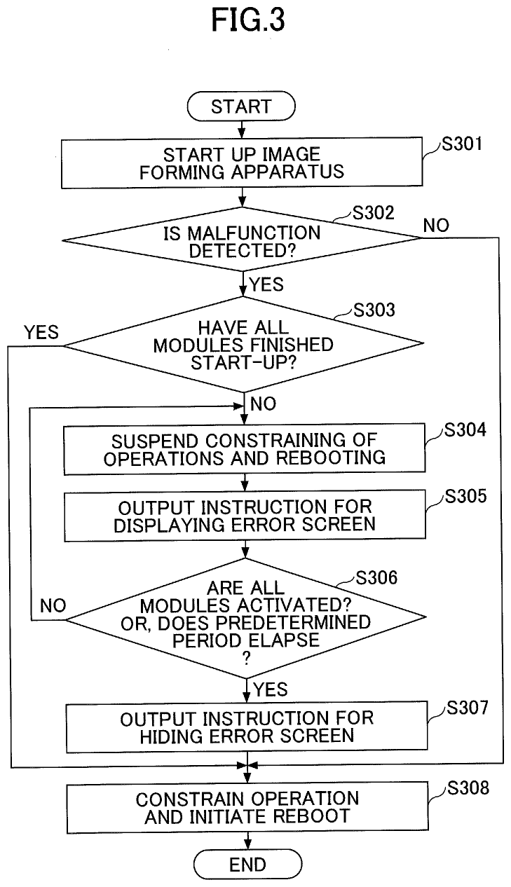

FIG. 3 is a flowchart illustrating an example of the operation of the image forming apparatus 10 according to the present embodiment.

First, in step S301, the image forming apparatus 10 starts in accordance with a user turning on a power switch, or the like.

Subsequently, in step S302, the malfunction detector 153 detects the presence or absence of a malfunction of the image forming apparatus 10 at start-up.

When a malfunction is detected (Yes in step S302), in step 303, the determining unit 154, which has received a signal indicating that the malfunction is detected, determines whether or not all modules have finished start-up. The determining unit 154 further outputs a signal indicating a determined result to the reboot unit 156.

In step S303, when it is determined that all modules have not finished start-up (No in step S303), the reboot unit 156, which has received a signal indicating that all modules have not finished start-up, in step S304 suspends a process of operation constraints and a reboot operation, without performing the process and operation.

Subsequently, in step S305, the reboot unit 156 outputs a display instruction of an error screen on which information indicating that the malfunction is detected is displayed, to the operating controller 152. The operating controller 152 outputs the display instruction received from the reboot unit 156 to the monitoring unit 251. The monitoring unit 251 outputs the display instruction received from the operating controller 152 to the display 252. The display 252 displays an error screen in accordance with the display instruction received from the monitoring unit 251.

Note that the order of step S304 and step S305 can be appropriately changed. Also, the process of step S304 and the process of step S305 may be executed in parallel.

Subsequently, in step S306, the determining unit 154 determines whether or not all the modules are activated, and outputs a signal indicating a determined result to the reboot unit 156. The timer 155 outputs a signal indicating time elapsing after the malfunction is detected, to the reboot unit 156.

When it is determined that all the modules are activated, or when a predetermined period elapses after the malfunction is detected (Yes in step S306), in step S307, the reboot unit 156 outputs an instruction for hiding an error screen to the operating controller 152. The operating controller 152 outputs the hiding instruction received from the reboot unit 156 to the monitoring unit 251. The monitoring unit 251 outputs the hiding instruction received from the operating controller 152 to the display 252. The display 252 hides the displayed error screen in accordance with the hiding instruction received from the monitoring unit 251.

Subsequently, in step S308, the reboot unit 156 resumes the process of operation constraints and the reboot operation, which are suspended.

Note that the order of step S307 and step S308 can be appropriately changed. The process of step S307 and the process of step S308 may be executed in parallel.

On the other hand, in step S302, when a malfunction is not detected (NO in step S302), the process proceeds to step S308. In step S308, the reboot unit 156 executes the process of operation constraints, and then performs the reboot operation.

In step S303, when it is determined that all modules have finished start-up (YES in step S303), the process proceeds to step S308. In step S308, the reboot unit 156 executes the process of operation constraints, and then performs the reboot operation.

As a result of the steps described above, even immediately after the image forming apparatus 10 starts, the image forming apparatus 10 prevents the reboot operation from being performed in an unstable state in which all modules are not completely activated. The image forming apparatus 10 can automatically perform the reboot operation as suited, when a malfunction occurs.

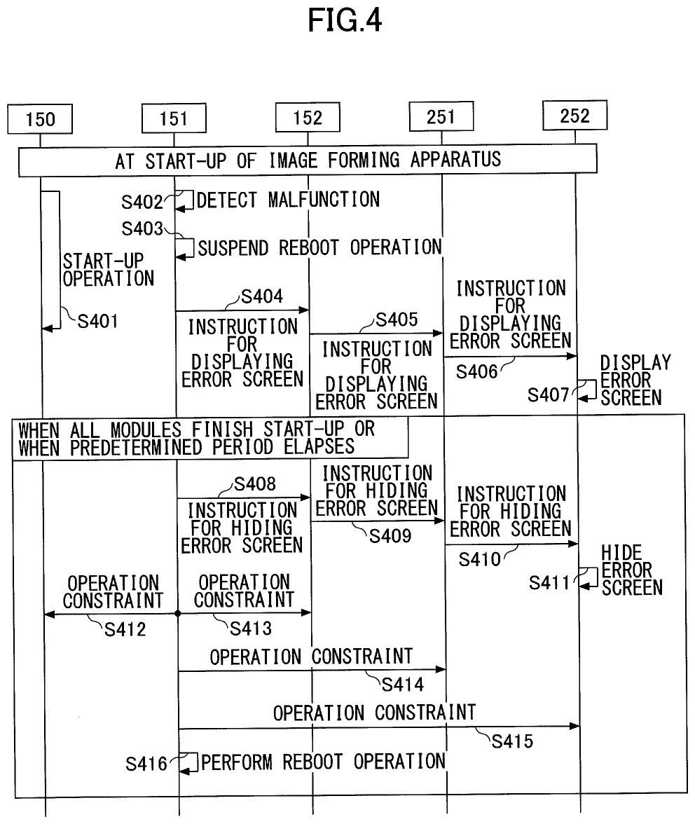

Hereafter, FIG. 4 is a sequence diagram illustrating an example of the operation of the image forming apparatus 10 according to the present embodiment.

When the image forming apparatus 10 starts, in step S401, all modules such as the module group 150 are activated. In this case, since each module takes a different amount of time to start, all modules do not finish starting simultaneously. In other words, the modules finish the start-up sequentially.

Subsequently, in step S402, when a malfunction of the image forming apparatus 10 is detected at start-up of the image forming apparatus 10, the system controller 151 determines whether or not all modules have finished start-up.

When all modules have not finished start-up, in step S403, the system controller 151 suspends a process of operation constraints and a reboot operation, without performing the process and operation.

Subsequently, in step S404, the system controller 151 outputs a display instruction of an error screen to the operating controller 152.

Subsequently, in step S405, the operating controller 152 outputs the display instruction received from the system controller 151 to the monitoring unit 251. Next, in step S406, the monitoring unit 251 outputs the display instruction received from the operating controller 152 to the display 252.

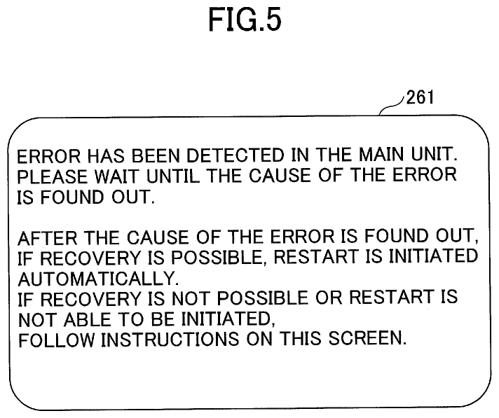

Subsequently, in step S407, the display 252 displays an error screen in accordance with the display instruction received from the monitoring unit 251. FIG. 5 is a diagram illustrating an example of an error screen 261 displayed on the display 252. In the example of FIG. 5, an error status of the image forming apparatus 10; a way of addressing error by the image forming apparatus 10; and a message for indicating to a user a solution; are displayed.

Referring back to FIG. 4, the operation of the image forming apparatus 10 will be described.

Even after the reboot unit 156 suspends the reboot operation, each module continues to start. In such a manner, the system controller 151 continuously determines whether or not all modules have finished start-up.

When it is determined that all modules have finished the start-up, in step S408, the system controller 151 outputs an instruction for hiding an error screen to the operating controller 152.

Subsequently, in step S409, the operating controller 152 outputs the hiding instruction received from the system controller 151 to the monitoring unit 251. Next, in step S410, the monitoring unit 251 outputs the hiding instruction received from the operating controller 152 to the display 252.

Subsequently, in step S411, the display 252 hides the displayed error screen in accordance with the hiding instruction received from the monitoring unit 251.

Subsequently, in step S412, the system controller 151 executes a process of operation constraints on each module included in the module group 150.

Subsequently, in step S413, the system controller 151 executes a process of operation constraints on the operating controller 152. In step 414, the system controller 151 executes a process of operation constraints on the monitoring unit 251. In step S415, the system controller 151 executes a process of operation constraints on the display 252.

Note that the order of steps S412 through S415 can be appropriately changed. The process of steps S412 through S415 may be operated in parallel.

Subsequently, in step S416, the system controller 151 performs a reboot operation of the image forming apparatus 10.

As described above, when the functional units are coordinated, the image forming apparatus 10 prevents a reboot operation from being performed in an unstable state in which all modules are not completely activated immediately after the image forming apparatus 10 starts. Further, the image forming apparatus 10 can promptly perform a reboot operation automatically as suited.

### Effects or the Like

As described above, according to the present embodiment, when a malfunction is detected at start-up of the image forming apparatus 10, in a case where it is determined that all modules have not finished start-up, a reboot operation is suspended. After the suspension, when it is determined that all modules have finished the start-up or when a predetermined period elapses after the malfunction is detected, the reboot operation is resumed.

Thereby, in an unstable state in which all modules are not completely activated, the reboot operation is prevented from being performed. Accordingly, when a malfunction occurs, the reboot operation of the image forming apparatus 10 can be automatically performed as suited.

Further, the reboot operation is resumed when a predetermined period elapses after a malfunction is detected. Thereby, it is possible to prevent the reboot operation from being suspended too long. In this case, the process of operation constraints on only one or more activated modules that are detected by the determining unit 154 is executed. Thereby, the process of operation constraints can be efficiently executed.

Furthermore, information on error occurring at start-up is displayed on the display 252. Thereby, a status in which the image forming apparatus 10 is starting can be timely presented to a user accurately. Accordingly, it is possible to avoid erroneous operation by a user at start-up of the image forming apparatus 10.

### Second Embodiment

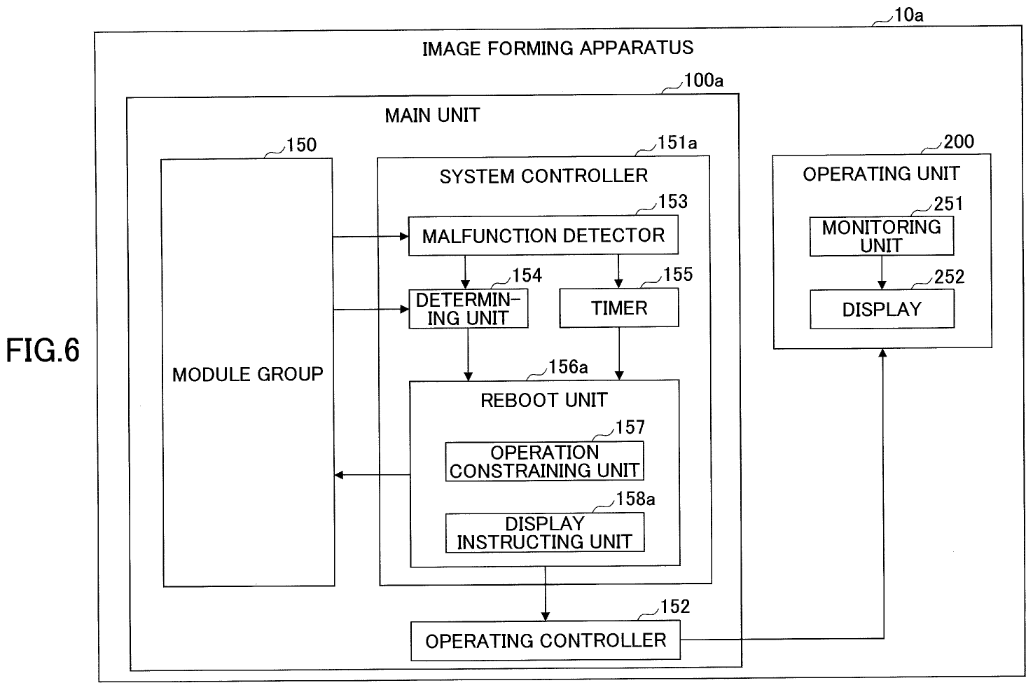

Hereafter, an image forming apparatus according to a second embodiment will be described with reference to FIGS. 6 to 9. Note that for the same configuration as the first embodiment described above, explanation will be omitted.

The image forming apparatus according to the present embodiment performs a reboot operation when a malfunction is detected at start-up of the image forming apparatus; subsequently, when a malfunction is detected again during a restart of the image forming apparatus, the reboot operation is terminated while information indicative of the malfunction is displayed on a display.

### Functional Configuration of Image Forming Apparatus According to the Second Embodiment

The image forming apparatus 10a according to the present embodiment is implemented by function blocks illustrated in FIG. 6, or the like. FIG. 6 is a block diagram illustrating an example of a functional configuration of the image forming apparatus 10a according to the present embodiment.

A main unit 100a of the image forming apparatus 10a includes a system controller 151a including a reboot unit 156a. The reboot unit 156a includes a display instructing unit 158a.

When a malfunction is detected at start-up of the image forming apparatus 10a, the reboot unit 156a performs the reboot operation. After the reboot operation, when a malfunction is detected again during a restart of the image forming apparatus 10a, the reboot unit 156a terminates the reboot operation.

In other words, when time elapsing after a time point of the detected preceding malfunction, which is measured by the timer 155, is smaller than or equal to a predetermined threshold, the reboot unit 156a determines that a malfunction is detected again during the restart initiated by the performed reboot operation. The reboot unit 156a then terminates the reboot operation.

When the reboot operation is terminated, the reboot unit 156a outputs a display instruction of a malfunction screen on which information indicating that a malfunction is detected is displayed, to the operating unit 200 via the display instructing unit 158a. As a result, a malfunction screen is displayed on the display 252. In the present embodiment, the malfunction screen is an example of “information indicating a malfunction”.

Note that the term “terminate” differs from “suspend” used in the first embodiment. The “terminate” means cancellation without resuming a reboot operation.

### Operation of Image Forming Apparatus According to the Second Embodiment

Hereafter, the operation of the image forming apparatus will be described according to the present embodiment.

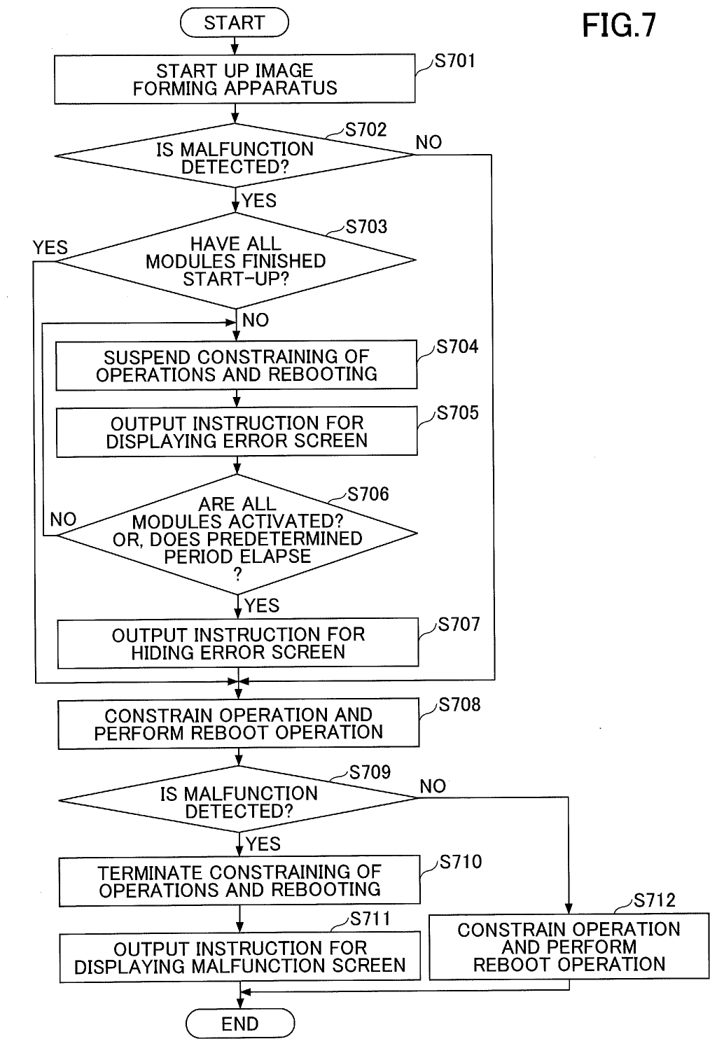

FIG. 7 is a flowchart illustrating an example of the operation of the image forming apparatus 10a according to the present embodiment. A process of steps S701 through S708 is same as the process of steps S301 through S308 in FIG. 3; accordingly, explanation will be omitted for steps S701 through S708.

In step S709, the malfunction detector 153 detects the presence or absence of a malfunction of the image forming apparatus 10a during a restart initiated by the performed reboot operation (step S708).

When a malfunction is detected (Yes in step S709), the malfunction detector 153 outputs a signal indicating that the malfunction is detected, to the reboot unit 156a via the determining unit 154.

Subsequently, in step S710, the reboot unit 156a terminates a process of operation constraints and a reboot operation.

Subsequently, in step S711, the reboot unit 156a outputs a display instruction of a malfunction screen to the operating controller 152. The operating controller 152 outputs the display instruction received from the reboot unit 156a to the monitoring unit 251. The monitoring unit 251 outputs the display instruction received from the operating controller 152 to the display 252. The display 252 displays a malfunction screen in accordance with the display instruction received from the monitoring unit 251.

Note that the order of step S710 and step S711 can be appropriately changed. The process of step S710 and the process of step S711 may be executed in parallel.

On the other hand, in step S709, when a malfunction is not detected (NO in step S709), in step S712, the reboot unit 156 performs the process of operation constraints and the reboot operation.

As a result of the steps described above, when a malfunction is determined again during the restart initiated by the performed reboot operation, the image forming apparatus 10a terminates the reboot operation, as well as displaying the malfunction screen on the display 252.

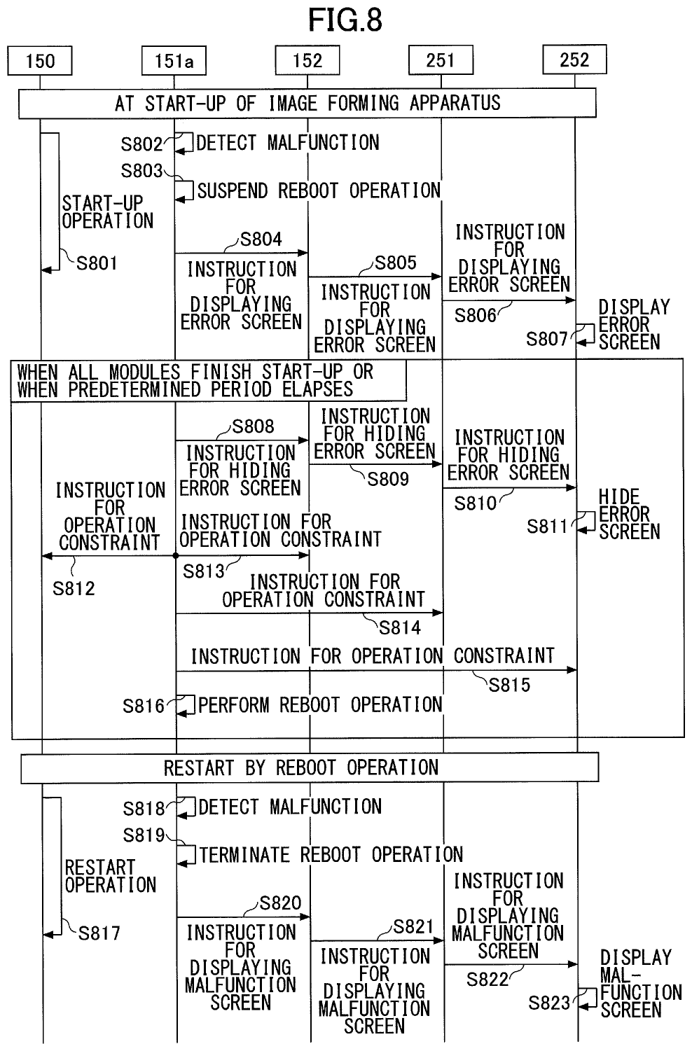

FIG. 8 is a sequence diagram illustrating an example of the operation of the image forming apparatus 10a according to the present embodiment. A process of steps S801 through S816 is same as the process of steps S401 through S416 in FIG. 4; accordingly, explanation will be omitted for steps S801 through S816.

When the image forming apparatus 10a is restarted in response to performing a reboot operation (step S816), in step S817, all modules such as the module group 150 are restarted. Even during the restart, each module takes a different amount of time to start. For this reason, all modules do not finish restarting simultaneously. In other words, the modules finish the restart sequentially.

Subsequently, in step S818, when a malfunction of the image forming apparatus 10a is detected during the restart, in step S819, the system controller 151a terminates the process of operation constraints and the reboot operation, without performing the process and operation.

Subsequently, in step S820, the system controller 151a outputs a display instruction of a malfunction screen to the operating controller 152.

Subsequently, in step S821, the operating controller 152 outputs the display instruction received from the system controller 151a to the monitoring unit 251. Next, in step S822, the monitoring unit 251 outputs the display instruction received from the operating controller 152 to the display 252.

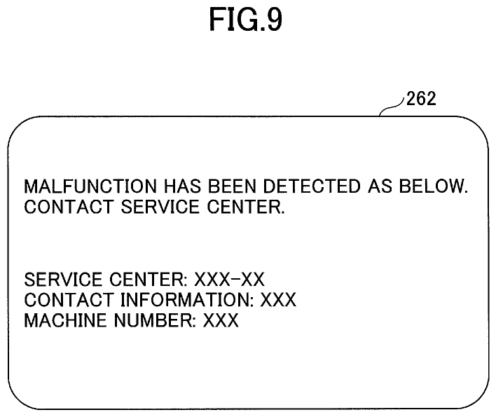

Subsequently, in step S823, the display 252 displays a malfunction screen in accordance with the display instruction received from the monitoring unit 251. FIG. 9 is a diagram illustrating an example of a malfunction screen 262 displayed on the display 252. In the example of FIG. 9, a malfunction status of the image forming apparatus 10; a way of addressing a malfunction by the image forming apparatus 10a; and a message for indicating to a user a solution; are displayed.

As described above, when the functional units are coordinated, in a case where a malfunction is detected again during a restart initiated after the performed reboot operation, the image forming apparatus 10a terminates the reboot operation. Further, the image forming apparatus 10a can promptly display the malfunction screen on the display 252.

### Effects or the Like

As described above, according to the present embodiment, when a malfunction is detected again during a restart initiated by the performed reboot operation, the reboot operation is terminated. Thereby, the reboot operation is prevented from being performed repeatedly. Accordingly, loss of time and power can be avoided.

Further, information on a malfunction detected during a restart initiated by the performed reboot operation is displayed on the display 252. Thereby, a status in which the image forming apparatus 10a is restarting can be timely presented to a user accurately. Accordingly, it is possible to avoid erroneous operation by a user during a restart of the image forming apparatus 10a.

The information processing apparatus has been described according to the embodiments. However, the present disclosure is not limited to the above embodiments, and various changes and modifications can be made within the scope of the present disclosure.

The embodiments also include a method for processing information. For example, the method for processing information includes: detecting the presence or absence of a malfunction of an information processing apparatus, the information processing apparatus including a display; performing a reboot operation upon detecting the malfunction; determining whether or not all modules have finished start-up; suspending the reboot operation to display predetermined information on the display, upon detecting the malfunction at start-up of the information processing apparatus and determining that all modules have not finished start-up; and hiding the predetermined information to resume the reboot operation, upon determining that all modules have finished the start-up or detecting a predetermined period elapsing after the malfunction is detected. Such a method for processing information can have similar effects to the information processing apparatus described above. The method for processing information may be implemented by a circuit such as a CPU or an LSI (Large-Scale Integration), an IC (Integrated Circuit) card, or a single module, or the like.

Further, the embodiments include a non-transitory recording medium. For example, the non-transitory recording medium causes a computer to execute a method. The method includes: detecting the presence or absence of a malfunction of an information processing apparatus, the information processing apparatus including a display; performing a reboot operation upon detecting the malfunction; determining whether or not all modules have finished start-up; suspending the reboot operation to display predetermined information on the display, upon detecting the malfunction at start-up of the information processing apparatus and determining that all modules have not finished start-up; and hiding the predetermined information to restart the reboot operation, upon determining that all modules have finished the start-up or detecting a predetermined period elapsing after the malfunction is detected. Such a recording medium can have similar effects to the information processing apparatus described above.

What is claimed is:

1. An information processing apparatus comprising:
a display;
at least one memory;
at least one processor electrically coupled to the memory, the processor being configured to:
detect the presence or absence of a malfunction of the information processing apparatus;
perform a reboot operation upon detecting the malfunction;
determine whether or not all modules have finished start-up;
suspend the reboot operation to display predetermined information on the display, upon detecting the malfunction at start-up of the information processing apparatus and determining that all modules have not finished start-up; and
hide the predetermined information to resume the reboot operation, upon determining that all modules have finished the start-up or detecting a predetermined period elapsing after the malfunction is detected.

2. The information processing apparatus according to claim 1, wherein the processor is configured to terminate the reboot operation upon again detecting a malfunction of the information processing apparatus during a restart of the information processing apparatus, the restart being initiated by the resumed reboot operation.

3. The information processing apparatus according to claim 2, wherein the processor is configured to terminate the reboot operation and display information indicating the malfunction on the display.

4. A method for processing information comprising:
detecting the presence or absence of a malfunction of an information processing apparatus, the information processing apparatus including a display;
performing a reboot operation upon detecting the malfunction;
determining whether or not all modules have finished start-up;
suspending the reboot operation to display predetermined information on the display, upon detecting the malfunction at start-up of the information processing apparatus and determining that all modules have not finished start-up; and
hiding the predetermined information to resume the reboot operation, upon determining that all modules have finished the start-up or detecting a predetermined period elapsing after the malfunction is detected.

5. The method according to claim 4, further comprising terminating the reboot operation upon again detecting a malfunction of the information processing apparatus during a restart of the information processing apparatus, the restart being initiated by the resumed reboot operation.

6. The method according to claim 5, further comprising terminating the reboot operation and displaying information indicating the malfunction on the display.

7. A non-transitory recording medium that causes a computer to execute a method, the method comprising:
detecting the presence or absence of a malfunction of an information processing apparatus, the information processing apparatus including a display;
performing a reboot operation upon detecting the malfunction;
determining whether or not all modules have finished start-up;
suspending the reboot operation to display predetermined information on the display, upon detecting the malfunction at start-up of the information processing apparatus and determining that all modules have not finished start-up; and
hiding the predetermined information to restart the reboot operation, upon determining that all modules have finished the start-up or detecting a predetermined period elapsing after the malfunction is detected.

8. The non-transitory recording medium according to claim 7, wherein the method further comprises terminating the reboot operation upon again detecting a malfunction of the information processing apparatus during a restart of the information processing apparatus, the restart being initiated by the resumed reboot operation.

9. The non-transitory recording medium according to claim 8, wherein the method further comprises terminating the reboot operation and displaying information indicating the malfunction on the display.
